(19) United States
(12) Patent Application Publication
(10) Pub. No.: US 2026/0173077 A1
(43) Pub. Date: Jun. 18, 2026

(54) METHOD, APPARATUS AND SYSTEM FOR SCHEDULING UE COOPERATION TRANSMISSION

(71) Applicant: Huawei Technologies Co., Ltd., Shenzhen (CN)

(72) Inventors: Hua Xu, Ottawa (CA); Jianglei Ma, Ottawa (CA)

(21) Appl. No.: 19/401,206

(22) Filed: Nov. 25, 2025

Related U.S. Application Data
(63) Continuation of application No. PCT/CN2024/104606, filed on Jul. 10, 2024.
(60) Provisional application No. 63/513,671, filed on Jul. 14, 2023.

(51) Int. Cl. H04W 72/1273; H04W 72/23

(52) U.S. Cl. CPC H04W 72/1273; H04W 72/23

(57) ABSTRACT

Systems and methods of scheduling for lower-layer transport block based UE cooperation are provided. One or more PDCCH are used to schedule a joint UE transmission involving a first UE, from which data is originated, and a second UE. This may involve transmission of a single PDCCH to the first UE, or transmitting a respective PDCCH to each of the first UE and the second UE. The first UE conveys data to the second UE over an inter-UE connection and transmits a first TB based on scheduling information in the PDCCH. The second UE transmits a second TB as part of the joint/UC transmission. Various design options for downlink control information carrying the scheduling information are provided.

### CROSS-REFERENCE TO RELATED APPLICATION

The present application is a continuation of International Application No. PCT/CN 2024/104606, filed on Jul. 10, 2024, which claims priority to, U.S. provisional patent application Ser. No. 63/513,671, entitled “METHOD, APPARATUS AND SYSTEM FOR SCHEDULING UE COOPERATION TRANSMISSION”, filed on Jul. 14, 2023. The entire contents of each of these applications are hereby incorporated by reference.

### TECHNICAL FIELD

The application relates to wireless communications generally, and more generally to a method, apparatus and system for scheduling user equipment (UE) cooperation transmission.

### BACKGROUND

In conventional wireless communication systems, each UE transmits/receives to/from the base station by itself; such systems can be viewed as being more cell-centric in nature. UE-to-UE communication has been studied and specified in the form of device to device communications to improve the communication between UEs directly.

UE cooperation (UC) concerns configuring a group of UEs to work together to improve transmission/reception to the base station as well as between UE(s). This can be viewed as more UE-centric in nature. This can be used to complement the conventional cell-centric system and improve overall system performance and capacity.

UE cooperation is a new subject in 3GPP. In Rel-18, it is studied and specified under the subject of multi-path support and UE aggregation. The main goal is to improve the uplink (UL) throughput and reliability by increasing the overall aggregated UE transmit power, which is considered the bottleneck in UL for 5G systems.

3GPP refers to 3^{rd} generation partnership project. 5G refers to 5^{th} generation, and more generally a number followed by “G” refers to that number generation of wireless communication system.

### SUMMARY

Methods, apparatuses and systems of scheduling for lower-layer transport block based UE cooperation are provided. One or more PDCCHs are used to schedule a UE cooperation (UC) transmission involving a source UE (SUE) and a cooperative UE (CUE). This may involve transmission of a single PDCCH to the source UE, or transmitting a respective PDCCH to each of the source UE and the cooperative UE. The source UE conveys data to the cooperative UE over an inter-UE connection and transmits a first TB based on scheduling information in the PDCCH. The cooperative UE transmits a second TB as part of the UC transmission. Various design options for downlink control information carrying the scheduling information are provided.

According to one aspect of the present disclosure, there is provided a method in a first user equipment (UE), the method comprising: receiving a first physical downlink control channel (PDCCH) scheduling a UE cooperation (UC) transmission for the first UE in a source UE (SUE) role; conveying data to a second UE in a cooperative UE (CUE) role over an inter-UE connection for transmission by the second UE; transmitting a first transport block (TB) based on the first PDCCH.

In some implementations, when the UC transmission is a TB duplicate UC transmission, the data is a duplicate of the first TB, or the data can be used to generate the first TB; when the UC transmission is a TB split UC transmission, the data is a second TB different than the first TB, or the data can be used to generate the second TB.

In some implementations, the first PDCCH includes an indication of whether the UC transmission is to be the TB duplicate UC transmission or the TB split UC transmission.

In some implementations, the method further comprises: receiving higher layer signalling to indicate whether the UC transmission is the TB duplicate UC transmission or the TB split UC transmission.

In some implementations, the first PDCCH contains scheduling information for only the first TB to indicate that the TB duplicate UC transmission is being scheduled; or the first PDCCH contains scheduling information for the first TB and the second TB to indicate that the TB split UC transmission is being scheduled.

In some implementations, the first PDCCH contains scheduling information for two TBs and in a case where the scheduling information for the two TBs is the same, the TB duplicate UC transmission is being scheduled, and in a case where the scheduling information for the two TBs is different, the TB split UC transmission is being scheduled.

In some implementations, the first PDCCH is scrambled with a first radio network temporary identifier (RNTI) to indicate the TB duplicate UC transmission and the first PDCCH is scrambled with a second RNTI to indicate the TB split UC transmission.

In some implementations, the method further comprises: receiving a second PDCCH scheduling a transmission of normal UE transmission; wherein the first PDCCH is scrambled with a first radio network temporary identifier (RNTI) to indicate that the first PDCCH is scheduling UC transmission and the second PDCCH is scrambled with a second RNTI to indicate that the second PDCCH is scheduling the normal UE transmission.

In some implementations, for the TB duplicate UC transmission, the first PDCCH contains a new data indicator (NDI) indicating whether a new transmission is being scheduled or a retransmission is being scheduled.

In some implementations, for the TB split UC transmission, the first PDCCH contains a first new data indicator (NDI) indicating whether a new transmission or a retransmission is being scheduled for transmission by the first UE, and contains a second new data indicator (NDI) indicating whether a new transmission or a retransmission is being scheduled for transmission by the second UE in the CUE role.

According to another aspect of the present disclosure, there is provided an apparatus in a user equipment (UE) comprising at least one processor coupled with a memory storing instructions, wherein when the instructions executed by the at least one processor, cause the UE to execute a method comprising: receiving a first physical downlink control channel (PDCCH) scheduling a UE cooperation (UC) transmission for the UE in a source UE (SUE) role; conveying data to a second UE in a cooperative UE (CUE) role over an inter-UE connection for transmission by the second UE; transmitting a first transport block (TB) based on the PDCCH.

In some implementations, when the UC transmission is a TB duplicate UC transmission, the data is a duplicate of the first TB, or data can be used to generate the first TB; when the UC transmission is a TB split UC transmission, the data is a second TB different than the first TB, or the data can be used to generate the second TB.

In some implementations, the first PDCCH includes an indication of whether the UC transmission is to be the TB duplicate UC transmission or the TB split UC transmission.

In some implementations, the apparatus further comprises: receiving higher layer signalling to indicate whether the UC transmission is the TB duplicate UC transmission or the TB split UC transmission.

In some implementations, the first PDCCH contains scheduling information for only the first TB to indicate the TB duplicate UC transmission is being scheduled; the first PDCCH contains scheduling information for the first TB and the second TB to indicate the TB split UC transmission is being scheduled.

In some implementations, the first PDCCH contains scheduling information for two TBs and in a case where the scheduling information for the two TBs is the same, the TB duplicate UC transmission is being scheduled, and in a case where the scheduling information for the two TBs is different, the TB split UC transmission is being scheduled.

In some implementations, the first PDCCH is scrambled with a first radio network temporary identifier (RNTI) to indicate the TB duplicate UC transmission and the first PDCCH is scrambled with a second RNTI to indicate the TB split UC transmission.

In some implementations, the apparatus further comprises: receiving a second PDCCH scheduling a transmission of normal UE transmission; the second PDCCH is scrambled with a second RNTI to indicate the normal UE transmission.

In some implementations, for the TB duplicate UC transmission, the first PDCCH contains a new data indicator (NDI) indicating whether a new transmission is being scheduled or a retransmission is being scheduled.

In some implementations, for the TB split UC transmission, the first PDCCH contains a first new data indicator (NDI) indicating whether a new transmission or a retransmission is being scheduled for transmission by the first UE, and contains a second new data indicator (NDI) indicating whether a new transmission or a retransmission is being scheduled for transmission by the second UE in the CUE role.

According to another aspect of the present disclosure, there is provided a method in a network device, the method comprising: transmitting a first physical downlink control channel (PDCCH) scheduling a UE cooperation (UC) transmission for a first UE in a source UE (SUE) role; receiving a first TB based on scheduling information in the PDCCH from the first UE; receiving a second TB from a second UE in a cooperative UE (CUE) role based on data conveyed to the second UE by the first UE.

In some implementations, when the UC transmission is a TB duplicate UC transmission, the second TB is a duplicate of the first TB; when the UC transmission is a TB split UC transmission, the second TB is different than the first TB.

In some implementations, the first PDCCH includes an indication of whether the UC transmission is to be the TB duplicate UC transmission or the TB split UC transmission.

In some implementations, the method further comprises: transmitting higher layer signalling to indicate whether the UC transmission is the TB duplicate UC transmission or the TB split UC transmission.

In some implementations, the first PDCCH contains scheduling information for only the first TB to indicate that the TB duplicate UC transmission is being scheduled; the first PDCCH contains scheduling information for the first TB and a second TB to indicate that the TB split UC transmission is being scheduled.

In some implementations, the first PDCCH contains scheduling information for two TBs and in a case where the scheduling information for the two TBs is the same, the duplicate TB UC transmission is being scheduled, and in a case where the scheduling information for the two TBs is different, the split TB UC transmission is being scheduled.

In some implementations, the first PDCCH is scrambled with a first radio network temporary identifier (RNTI) to indicate the TB duplicate UC transmission and the first PDCCH is scrambled with a second RNTI to indicate the TB split UC transmission.

In some implementations, the method further comprises: transmitting a second PDCCH scheduling a transmission of normal UE transmission; wherein the first PDCCH is scrambled with a first radio network temporary identifier (RNTI) to indicate that the first PDCCH is scheduling UC transmission and the second PDCCH is scrambled with a second RNTI to indicate that the second PDCCH is scheduling the normal UE transmission.

In some implementations, for the TB duplicate UC transmission, the first PDCCH contains a new data indicator (NDI) indicating whether a new transmission is being scheduled or a retransmission is being scheduled.

In some implementations, for the TB split UC transmission, the first PDCCH contains a first new data indicator (NDI) indicating whether a new transmission or a retransmission is being scheduled for transmission by the first UE, and contains a second new data indicator (NDI) indicating whether a new transmission or a retransmission is being scheduled for transmission by the second UE in the CUE role.

According to another aspect of the present disclosure, there is provided an apparatus in a network device comprising at least one processor coupled with a memory storing instructions, wherein when the instructions executed by the at least one processor, cause the network device to execute a method comprising: transmitting a first physical downlink control channel (PDCCH) scheduling a UE cooperation (UC) transmission for a first UE in a source UE role; receiving a first transport block (TB) based on the first PDCCH from the first UE; receiving a second TB from a second UE in a cooperative UE role based on data conveyed to the second UE by the first UE.

In some implementations, when the UC transmission is a transport block (TB) duplicate UC transmission, the second TB is a duplicate of the first TB; when the UC transmission is a transport block (TB) split UC transmission, the second TB is different than the first TB.

In some implementations, the first PDCCH includes an indication of whether the UC transmission is to be the TB duplicate UC transmission or the TB split UC transmission.

In some implementations, the network device further comprises: transmitting higher layer signalling to indicate whether the UC transmission is the TB duplicate UC transmission or a TB split UC transmission.

In some implementations, the first PDCCH contains scheduling information for only the first TB to indicate that TB duplicate UC transmission is being scheduled; the first PDCCH contains scheduling information for the first TB and a second TB to indicate that TB split UC transmission is being scheduled.

In some implementations, the first PDCCH contains scheduling information for two TBs and in a case where the scheduling information for the two TBs is the same, the duplicate TB UC transmission is being scheduled, and in a case where the scheduling information for the two TBs is different, the split TB UC transmission is being scheduled.

In some implementations, the first PDCCH is scrambled with a first radio network temporary identifier (RNTI) to indicate the TB duplicate UC transmission and the first PDCCH is scrambled with a second RNTI to indicate the TB split UC transmission.

In some implementations, the network device further comprises: transmitting a second PDCCH scheduling a transmission of normal UE transmission; wherein the first PDCCH is scrambled with a first radio network temporary identifier (RNTI) to indicate that the first PDCCH is scheduling UC transmission and the second PDCCH is scrambled with a second RNTI to indicate that the second PDCCH is scheduling the normal UE transmission.

In some implementations, for the TB duplicate UC transmission, the first PDCCH contains a new data indicator (NDI) indicating whether a new transmission is being scheduled or a retransmission is being scheduled.

In some implementations, for the TB split UC transmission, the first PDCCH contains a first new data indicator (NDI) indicating whether a new transmission or a retransmission is being scheduled for transmission by the first UE, and contains a second new data indicator (NDI) indicating whether a new transmission or a retransmission is being scheduled for transmission by the second UE in the CUE role.

A method according to another aspect of the present disclosure involves receiving a first PDCCH scheduling a joint UE transmission for data originated from a first UE, conveying data from the first UE to a second UE over an inter-UE connection for transmission by the second UE, and transmitting a first TB based on the first PDCCH.

In some implementations, when the joint UE transmission is a TB duplicate joint UE transmission, the data is a duplicate of the first TB, or the data can be used to generate the first TB.

In some implementations, when the joint UE transmission is a TB split joint UE transmission, the data is a second TB different than the first TB, or the data can be used to generate the second TB.

In some implementations, the first PDCCH includes an indication of whether the joint UE transmission is to be the TB duplicate joint UE transmission or the TB split joint UE transmission.

In some implementations, a method further involves receiving higher layer signalling to indicate whether the joint UE transmission is the TB duplicate joint UE transmission or the TB split joint UE transmission.

In some implementations, the first PDCCH contains scheduling information for only the first TB to indicate that the TB duplicate joint UE transmission is being scheduled; or the first PDCCH contains scheduling information for the first TB and the second TB to indicate that the TB split joint UE transmission is being scheduled.

In some implementations, the first PDCCH contains scheduling information for two TBs and in a case where the scheduling information for the two TBs is the same, the TB duplicate joint UE transmission is being scheduled, and in a case where the scheduling information for the two TBs is different, the TB split joint UE transmission is being scheduled.

In some implementations, the first PDCCH is scrambled with a first RNTI to indicate the TB duplicate joint UE transmission and the first PDCCH is scrambled with a second RNTI to indicate the TB split joint UE transmission.

In some implementations, a method further involves receiving a second PDCCH scheduling a transmission of normal UE transmission, in which case the first PDCCH may be scrambled with a first RNTI to indicate that the first PDCCH is scheduling the joint UE transmission and the second PDCCH may be scrambled with a second RNTI to indicate that the second PDCCH is scheduling the normal UE transmission.

In some implementations, for the TB duplicate joint UE transmission, the first PDCCH contains an NDI indicating whether a new transmission is being scheduled or a retransmission is being scheduled.

In some implementations, for the TB split joint UE transmission, the first PDCCH contains a first NDI indicating whether a new transmission or a retransmission is being scheduled for transmission by the first UE, and contains a second NDI indicating whether a new transmission or a retransmission is being scheduled for transmission by the second UE.

According to yet another aspect of the present disclosure, an apparatus includes at least one processor coupled with a memory storing instructions, and the instructions, when executed by the at least one processor, cause a UE to execute a method. The method involves receiving a first PDCCH scheduling a joint UE transmission for data originated from the UE, conveying data to a second UE over an inter-UE connection for transmission by the second UE, and transmitting a first TB based on the first PDCCH.

In some implementations, when the joint UE transmission is a TB duplicate joint UE transmission, the data is a duplicate of the first TB, or data can be used to generate the first TB.

In some implementations, when the joint UE transmission is a TB split joint UE transmission, the data is a second TB different than the first TB, or the data can be used to generate the second TB.

In some implementations, the first PDCCH includes an indication of whether the joint UE transmission is to be the TB duplicate joint UE transmission or the TB split joint UE transmission.

In some implementations, a method further involves receiving higher layer signalling to indicate whether the joint UE transmission is the TB duplicate joint UE transmission or the TB split joint UE transmission.

In some implementations, the first PDCCH contains scheduling information for only the first TB to indicate the TB duplicate joint UE transmission is being scheduled, or the first PDCCH contains scheduling information for the first TB and the second TB to indicate the TB split joint UE transmission is being scheduled.

In some implementations, the first PDCCH contains scheduling information for two TBs and in a case where the scheduling information for the two TBs is the same, the TB duplicate joint UE transmission is being scheduled, and in a case where the scheduling information for the two TBs is different, the TB split joint UE transmission is being scheduled.

In some implementations, the first PDCCH is scrambled with a first RNTI to indicate the TB duplicate joint UE transmission and the first PDCCH is scrambled with a second RNTI to indicate the TB split joint UE transmission.

In some implementations, a method further involves receiving a second PDCCH scheduling a transmission of normal UE transmission, in which case the first PDCCH may be scrambled with a first RNTI to indicate that the first PDCCH is scheduling the joint UE transmission and the second PDCCH may be scrambled with a second RNTI to indicate the normal UE transmission.

In some implementations, for the TB duplicate joint UE transmission, the first PDCCH contains an NDI indicating whether a new transmission is being scheduled or a retransmission is being scheduled.

In some implementations, for the TB split joint UE transmission, the first PDCCH contains a first NDI indicating whether a new transmission or a retransmission is being scheduled for transmission by the first UE, and contains a second NDI indicating whether a new transmission or a retransmission is being scheduled for transmission by the second UE.

A further aspect of the present disclosure relates to a method that involves transmitting a first PDCCH scheduling a joint UE transmission for data originated from a first UE, receiving a first TB of data based on scheduling information in the first PDCCH from the first UE, and receiving a second TB of data from a second UE based on data conveyed to the second UE from the first UE.

In some implementations, when the joint UE transmission is a TB duplicate joint UE transmission, the second TB is a duplicate of the first TB.

In some implementations, when the joint UE transmission is a TB split joint UE transmission, the second TB is different than the first TB.

In some implementations, the first PDCCH includes an indication of whether the joint UE transmission is to be the TB duplicate joint UE transmission or the TB split joint UE transmission.

In some implementations, a method further involves transmitting higher layer signalling to indicate whether the joint UE transmission is the TB duplicate joint UE transmission or the TB split joint UE transmission.

In some implementations, the first PDCCH contains scheduling information for only the first TB to indicate that the TB duplicate joint UE transmission is being scheduled, or the first PDCCH contains scheduling information for the first TB and a second TB to indicate that the TB split joint UE transmission is being scheduled.

In some implementations, the first PDCCH contains scheduling information for two TBs and in a case where the scheduling information for the two TBs is the same, the duplicate TB joint UE transmission is being scheduled, and in a case where the scheduling information for the two TBs is different, the split TB joint UE transmission is being scheduled.

In some implementations, the first PDCCH is scrambled with a first RNTI to indicate the TB duplicate joint UE transmission and the first PDCCH is scrambled with a second RNTI to indicate the TB split joint UE transmission.

In some implementations, a method further involves transmitting a second PDCCH scheduling a transmission of normal UE transmission, in which case the first PDCCH may be scrambled with a first RNTI to indicate that the first PDCCH is scheduling the joint UE transmission and the second PDCCH may be scrambled with a second RNTI to indicate that the second PDCCH is scheduling the normal UE transmission.

In some implementations, for the TB duplicate joint UE transmission, the first PDCCH contains an NDI indicating whether a new transmission is being scheduled or a retransmission is being scheduled.

In some implementations, for the TB split joint UE transmission, the first PDCCH contains a first NDI indicating whether a new transmission or a retransmission is being scheduled for transmission by the first UE, and contains a second NDI indicating whether a new transmission or a retransmission is being scheduled for transmission by the second UE.

An apparatus according to a further aspect of the present disclosure includes at least one processor coupled with a memory storing instructions, and the instructions, when executed by the at least one processor, cause a network device to execute a method. Such a method may involve transmitting a first PDCCH scheduling a joint UE transmission for data originated from a first UE; receiving a first TB of data based on the first PDCCH from the first UE; and receiving a second TB of data from a second UE based on data conveyed to the second UE from the first UE.

In some implementations, when the joint UE transmission is a TB duplicate joint UE transmission, the second TB is a duplicate of the first TB.

In some implementations, when the joint UE transmission is a TB split joint UE transmission, the second TB is different than the first TB.

In some implementations, the first PDCCH includes an indication of whether the joint UE transmission is to be the TB duplicate joint UE transmission or the TB split joint UE transmission.

In some implementations, a method further involves transmitting higher layer signalling to indicate whether the joint UE transmission is the TB duplicate joint UE transmission or a TB split joint UE transmission.

In some implementations, the first PDCCH contains scheduling information for only the first TB to indicate that TB duplicate joint UE transmission is being scheduled or the first PDCCH contains scheduling information for the first TB and a second TB to indicate that TB split joint UE transmission is being scheduled.

In some implementations, the first PDCCH contains scheduling information for two TBs and in a case where the scheduling information for the two TBs is the same, the duplicate TB joint UE transmission is being scheduled, and in a case where the scheduling information for the two TBs is different, the split TB joint UE transmission is being scheduled.

In some implementations, the first PDCCH is scrambled with a first RNTI to indicate the TB duplicate joint UE transmission and the first PDCCH is scrambled with a second RNTI to indicate the TB split joint UE transmission.

In some implementations, a method further involves transmitting a second PDCCH scheduling a transmission of normal UE transmission, in which case the first PDCCH may be scrambled with a first RNTI to indicate that the first PDCCH is scheduling the joint UE transmission and the second PDCCH may be scrambled with a second RNTI to indicate that the second PDCCH is scheduling the normal UE transmission.

In some implementations, for the TB duplicate joint UE transmission, the first PDCCH contains an NDI indicating whether a new transmission is being scheduled or a retransmission is being scheduled.

In some implementations, for the TB split joint UE transmission, the first PDCCH contains a first NDI indicating whether a new transmission or a retransmission is being scheduled for transmission by the first UE, and contains a second NDI indicating whether a new transmission or a retransmission is being scheduled for transmission by the second UE.

According to another aspect of the present disclosure, there is provided a computer program comprising instructions. The instructions, when executed by a processor, may cause the processor to implement the method of any one of any one of above aspects or implementations.

According to another aspect of the present disclosure, there is provided a non-transitory computer-readable medium storing instructions, the instructions, when executed by a processor, may cause the processor to implement the method of any one of any one of above aspects or implementations.

According to another aspect of the present disclosure, there is provided a system comprising a UE referenced in any one of above aspects or implementations and a network device referenced in any one of above aspects or implementations.

### BRIEF DESCRIPTION OF THE DRAWINGS

Embodiments of the disclosure will now be described with reference to the attached drawings in which:

FIG. 1 is a block diagram of a communication system;

FIG. 2 is a block diagram of a communication system;

FIG. 3 is a block diagram of a communication system showing a basic component structure of an electronic device (ED) and a base station;

FIG. 4 is a block diagram of modules that may be used to implement or perform one or more of the steps of embodiments of the application;

FIG. 5 is a block diagram that illustrates joint scheduling for User Equipment Cooperation;

FIG. 6 is a block diagram that illustrates bit level scrambling and physical downlink control channel (PDCCH) cyclic redundancy check (CRC) scrambling;

FIG. 7 is a block diagram that illustrates two types of data transmission;

FIG. 8A is a block diagram that illustrates a first type of transport block (TB)-based User Equipment Cooperation (UC) referred to as split TB UC data transmission;

FIG. 8B is a block diagram that illustrates a second type of transport block (TB)-based User Equipment Cooperation (UC) referred to as duplicate TB UC data transmission;

FIG. 9A is a block diagram where higher layer signalling is used to indicate transport block (TB)-split User Equipment Cooperation (UC) data transmission;

FIG. 9B is a block diagram where higher layer signalling is used to indicate transport block (TB)-duplicate User Equipment Cooperation (UC) data transmission;

FIG. 10 is a block diagram of an example of a common physical downlink control channel (PDCCH) carrying a common downlink control information (DCI) for scheduling two transport blocks (2TB);

FIG. 11 is a block diagram of an embodiment where separate physical downlink control channels (PDCCH) for source user equipment (SUE) and cooperative user equipment (CUE);

FIG. 12 is a flowchart of an example of a method for execution by a user equipment (UE) acting as a source user equipment (SUE), featuring TB duplication;

FIG. 13 is a flowchart of an example of a method for execution by a user equipment (UE) acting as a source user equipment (SUE), featuring TB split;

FIG. 14 is a flowchart of an example of a method for execution by a user equipment (UE) acting as a cooperative user equipment (CUE);

FIG. 15 is a block diagram that illustrates Inter-UE data transmission that employs transport block (TB) buffers and circular block buffers in the PHY layers of the source user equipment (SUE) and cooperative user equipment (CUE);

FIG. 16 is a block diagram that illustrates hybrid automatic repeat request (HARQ) control by the source user equipment (SUE) MAC layer;

FIG. 17 is a block diagram that illustrates hybrid automatic repeat request (HARQ) control by the cooperative user equipment (CUE) MAC layer;

FIG. 18 is a block diagram that shows an example of data/signaling flow for user equipment cooperation (UC) with transport block (TB) duplicate method;

FIG. 19 is a block diagram that shows an example of data/signaling flow for user equipment cooperation (UC) with transport block (TB) split method; and

FIG. 20 is a block diagram that illustrates code block group (CBG) based re-transmission for user equipment cooperation (UC).

### DETAILED DESCRIPTION OF THE ILLUSTRATIVE EMBODIMENTS

In the systems under study in 3GPP Rel-18, as part of the UE cooperation approach, data split/duplication is performed at the packet data control protocol (PDCP) layer. This approach may not fully exploit the dynamic channel variations.

As compared with PDCP layer data split/duplicate, UE cooperation (UC) at a lower protocol layer could be used to further improve the performance such as throughput and latency. For example, transport block (TB)-based UC may be better suited to exploit dynamic channel variation and maximize performance. Systems and methods of scheduling TB-based UC are provided.

In future generations of wireless communication (e.g., 5.5G or 6G), a large number of devices (mobile phones/devices, Internet of things (IOT) devices, cooperative UE (CUE), industry sensors/monitor etc) could be deployed.

UE cooperation could be employed to meet the needs of low power, long battery life, limited capability, capability/coverage enhancement etc. To be more specific, the data originated/destined from/to one device (source/target device) could be transmitted/received by a group of cooperative devices.

The connection between UEs for UC purposes may not necessarily be specified by 3GPP and can be achieved by non-3GPP connection including a wired or wireless connection.

Joint scheduling can be used to facilitate UC transmission/reception. Joint scheduling could include scheduling information for multiple data packets (or the same duplicated packets) from the source devices (such as SUE) and their respective transmission via multiple cooperative devices (such as CUE and the SUE).

The scheduling information for each packet may include one or more of parameters such as: resource allocation (RA), modulation and coding scheme (MCS), HARQ ID, redundancy version (RV) etc. Joint scheduling could work with individual scheduling (per transmission or per device transmission without UC) together.

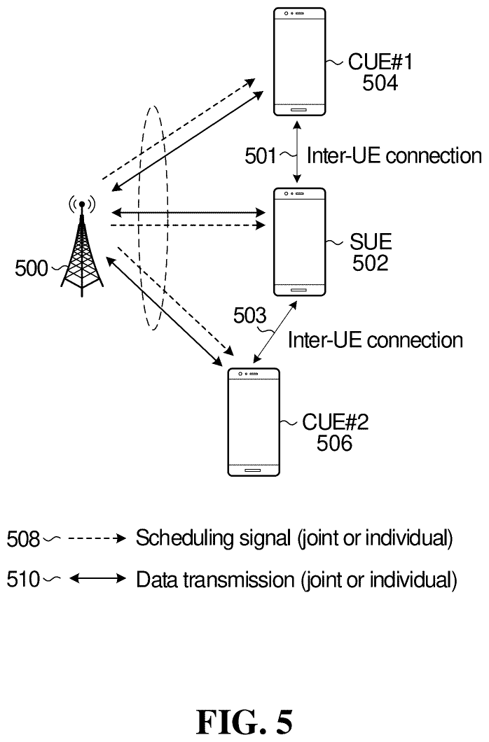

The scenarios described herein will generally focus on uplink UC transmission, but the provided methodologies can be applicable to both uplink and downlink transmission. Thus, for example, the data transmission as shown in FIG. 5 could be either uplink or downlink. Uplink data transmissions may be carried by a physical uplink shared channel (PUSCH) channel and downlink data transmissions may be carried by physical downlink shared channel (PDSCH) channel in 3GPP New Radio (NR) standard (aka 5G standard). Most mechanisms provided herein can be applicable to both uplink and downlink unless specified explicitly.

For example, for downlink UC transmission, the joint scheduling could include scheduling information for scheduling multiple data packets (or the same duplicated packets) transmissions from the source next generation (or 5G) base station (gNB) (or network device) to respective devices including the destined device (or destined/target UE, or target (or destined) UE (TUE)) and cooperative devices. The cooperative devices may relay the data packets to the TUE.

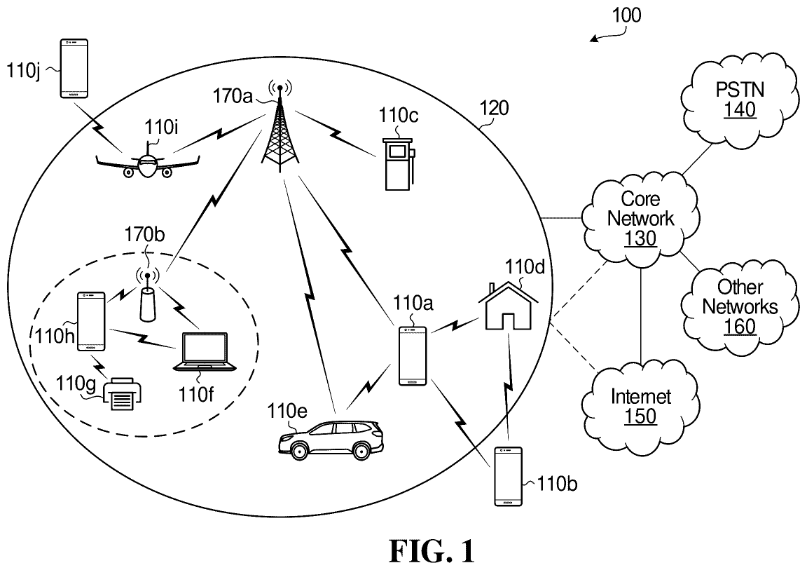

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

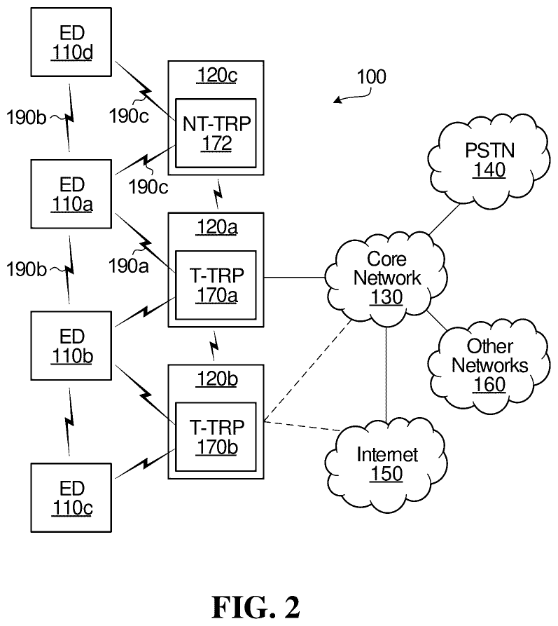

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery, and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-transport/receive point (TRPs)) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190 a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190 c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130 and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some, or all, of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies and may incorporate multiple transceivers necessary to support such operation.

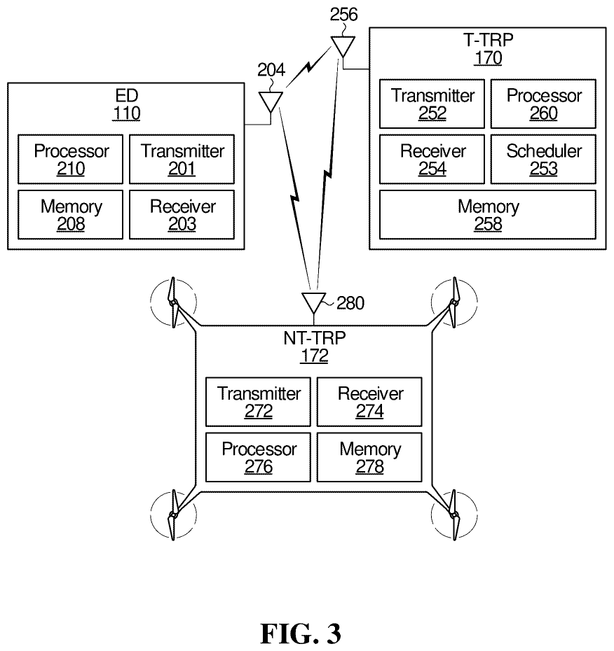

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 may also include at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random-access memory (RAM), read-only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signalling from the downlink transmission (e.g. by detecting and/or decoding the signalling). An example of signalling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP) ), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some implementations, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating and decoding received symbols.

The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signalling, e.g. to configure one or more parameters of the ED 110 and/or one or more parameters of the NT-TRP 172. Any signalling generated by the processor 260 is sent by the transmitter 252. Note that “signalling”, as used herein, may alternatively be called control signalling. Dynamic signalling may be transmitted in a control channel, e.g. a physical downlink control channel (PDCCH), and static or semi-static higher layer signalling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating and decoding received symbols. In some embodiments, the processor 276 implements the transmit beamforming and/or receive beamforming based on beam direction information (e.g. BAI) received from T-TRP 170. In some embodiments, the processor 276 may generate signalling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

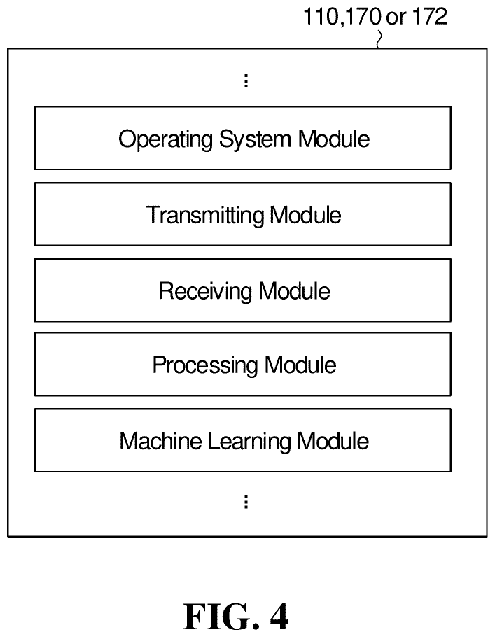

One or more steps of the methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor, for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Systems and methods of scheduling for lower layer UC data transmission, for example transport block (TB)-based UC transmission are provided. While the description focuses on TB-based UC transmission, the approach can be applied for other lower layer UC transmissions such as UC implemented/realized in MAC and PHY layers. The provided systems and methods may address/mitigate one or more of:
how to distinguish a PDCCH scheduling the UEs own data transmission (i.e., normal UE transmission, or normal UE data transmission) and an UC data transmission (i.e., UC transmission);
how to distinguish PDCCH for TB-split UC transmission and TB-duplicate UC transmission;
solution for reusing downlink control information (DCI) for UC transmission including data indicator (NDI) design;
UE behaviors for SUE and CUE for TB-based UC transmission;
Data/signaling flow for different types of TB-based UC transmission.

### Distinction Between Scheduling a UE's Own Traffic and UC Traffic as Well as Distinction Between Scheduling Different Types of UC Traffic

In this implementation, systems and methods for distinguishing between scheduling a UE's own traffic (or non-UC traffic) and UC traffic as well as distinguishing between scheduling different types of UC traffic are provided.

UC data transmission refers to a SUE and (one or more) CUE(s) cooperatively transmitting data from the SUE. The distinction between normal UE traffic (i.e., UE's own traffic) and UC traffic will be described with reference to FIG. 5. FIG. 5 shows a gNB 500, and three UEs 502,504,506. Any of the UEs may transmit its own data. In addition, one or more UEs may act as CUEs to assist in the data transmission of another UE acting as a SUE. In the example of FIG. 5, in a specific example of UC data transmission, UEs 504,506 are acting as CUEs to assist in the transmission of data from UE 502 which is acting as a SUE. There is an inter-UE connection 501 between UE 502 and UE 504, and another inter-UE connection 503 between UE 502 and UE 506. As mentioned above, these links may or may not be standardized by 3GPP. Also shown is the transmission of scheduling signal(s) 508 from the gNB 500 to the UEs 502,504,506 for the purpose of scheduling normal UE data transmission and UC data transmissions 510.

Embodiments may be described herein with reference primarily to UC data transmission, a SUE or target UE (TUE) and (one or more) CUE(s) cooperatively transmitting data from the SUE (and/or to a TUE). UC is a form of joint transmission by multiple UEs (for example an SUE and one or more CUEs), and “joint UE transmission” or “joint transmission” may also be used to refer to cooperatively transmitting data as disclosed herein. SUE, TUE, and CUE refer to UEs, and UE behaviors that may be different depending on whether a UE is acting as or implementing an SUE, TUE, or CUE, or in other words is in an SUE, TUE, or CUE role. Features disclosed herein in the context of an SUE, TUE, or CUE or a UE in an SUE, TUE, or CUE role, for example, apply more generally to UEs that may be configured or operative to work together for joint transmission of data.

The scheduling signals include a distinction between the two types of data transmission such that a UE receiving the scheduling signal knows whether it is a normal UE data transmission as opposed to a UC data transmission.

For example, where PDCCH scheduling is used for scheduling these two types of data transmission, the PDCCH scheduling needs to include a distinction between the two types of data transmission. Please note that in the present disclosure, the PDCCH scheduling a UC transmission or normal UE transmission could also be described as: the information (e.g., DCI) transmitted in the PDCCH scheduling a UC transmission or normal UE transmission.

In some embodiments, radio network temporary identifiers (RNTIs) are used for this purpose. Different RNTIs can be used to scramble contents of the PDCCH depending on whether the transmission being scheduled is a normal UE data transmission or a UC data transmission. In a specific example, a PDCCH scheduling normal UE data transmission by a UE uses a normal UE RNTI for scrambling, e. g, the transmitting UE's conventional C-RNTI, and a PDCCH scheduling UC data transmission uses a new UE RNTI for scrambling. More generally, different RNTIs known to both the transmitter and receiver can be used for the two purposes.

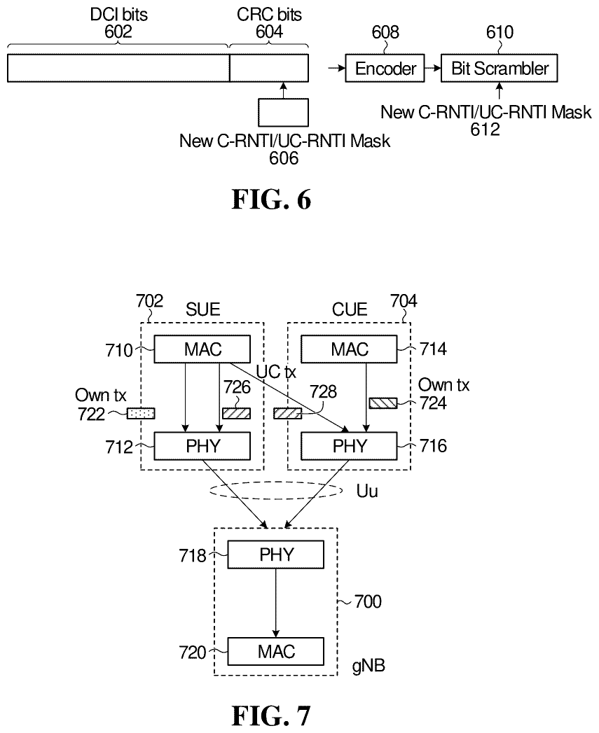

One or both of bit-level scrambling and PDCCH cyclic redundancy check (CRC) scrambling can be applied using this new UE RNTI or can be called UC RNTI. An example is shown in FIG. 6. In FIG. 6, at the transmitter, shown is a set of DCI bits 602 and generated CRC bits 604. This is subject to scrambling with an RNTI 606 which is one of two RNTIs that distinguish between normal UE data transmission and UC transmission. In the illustrated example, this is referred to as the “new RNTI” or UC RNTI, which is used to indicate UC transmission. In another way of applying this, shown is an encoder 608 which produces an encoded bit stream including CRC and this is subject to bit level scrambling in bit scrambler 610 with the new RNTI at 612.

In some embodiments, a common PDCCH is used for scheduling UC data transmission for both SUE and CUE. In this case, a new common RNTI can be configured and used for scrambling the common PDCCH. Both the SUE and CUE receive and process the common PDCCH. In some embodiments, a respective separate PDCCH is used for scheduling UC data transmission for the SUE and each CUE. In this case, the SUE and CUE each receive and process the respective separate PDCCH. In this case, separate new RNTI(s) could be configured for the SUE and each CUE respectively and used for scrambling PDCCHs for the SUE and each CUE for respective UC transmission.

### Distinction Between Scheduling Different Types of TB-Based UC Traffic

An example of TB-based UC data transmission will be further described with reference to FIG. 7 which shows a gNB 700, a first UE 702 configured to function as an SUE, and a second UE 704 configured to function as a CUE to assist in data transmission from the SUE 704. UE 702 has MAC and PHY layers 710,712. UE 704 has corresponding layers 714,716 and gNB 700 has corresponding layers 718, 720. A TB for transmission as normal UE data of the first UE 702 is indicated at 722, which shows TB 722 output by MAC 710 for processing by PHY 712. A TB for transmission as normal UE data of the second UE 704 is indicated at 724 which shows TB 724 output by MAC 714 for processing by PHY 716. Finally, TB(s) for UC transmission include a TB 726 output by MAC 710 for processing by PHY 712 and a TB 728 output by MAC 710 for being passed to the CUE 704 for processing by PHY 716 of the CUE.

In the context of the joint transmission example shown, the joint transmission is for data originated from the SUE 702. Such data may also be referred to, for example, as data that originates from the SUE 702.

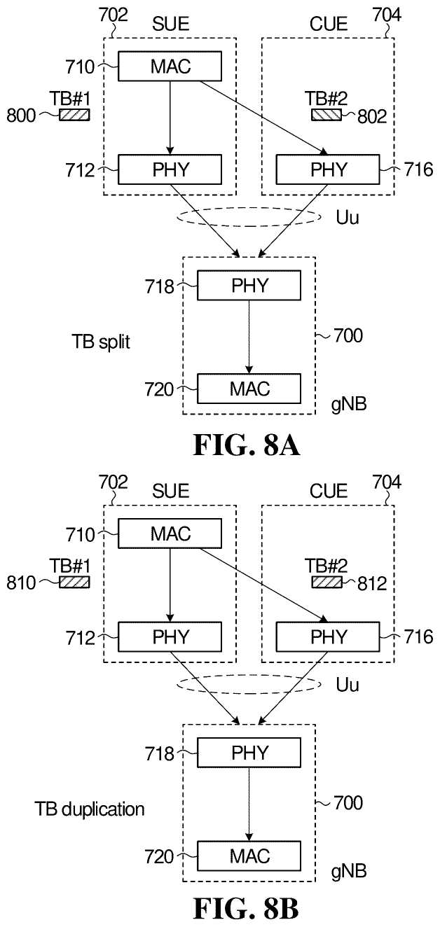

UC data transmission may be in the form of split UC data transmission or duplicate UC transmission. With split UC data transmission, the SUE and CUE are transmitting different data of the SUE, whereas with duplicate UC transmission, the SUE and CUE are transmitting the same data of the SUE. In a specific example, data duplication/split occurs at the TB level; examples of this are shown in FIGS. 8A and 8B, which show two types of TB-based UC. FIG. 8A shows split TB UC data transmission. In this case, for the UC transmission, a first TB 800 is transmitted by the source UE 702, and a second different TB 802 is conveyed from the SUE 702 to the CUE 704 for transmission by the CUE. In this case, two different TBs are transmitted to the gNB, one from the SUE and one from the CUE. Each TB is managed by a separate hybrid automatic repeat request (HARQ) process.

FIG. 8B shows duplicate TB UC data transmission. In this case, for the UC transmission, a first TB 810 is transmitted by the source UE 702, and a TB 812 conveyed to the CUE for transmission is a duplicate of the first TB 810. In this case, the same TB is duplicated and transmitted to the gNB from both the SUE and the CUE. The both TBs transmitted by the SUE and the CUE is managed by a single (the same) HARQ process, as the TB(s) contains the same data.

In the detailed examples described herein, it is assumed that UC transmission involves multiple UEs transmitting data cooperatively to a network devices such as gNB; however, UC transmission can alternatively involve multiple UEs cooperatively transmitting data to another UE (target UE).

In the detailed examples described herein, TB-based UC transmission (TB-duplicate or TB-split) is used. Other types of data duplication and data splitting may alternatively be employed (for example, data duplication or data split may not occur at TB level but in other unit/format/packet) and similar mechanisms to those described herein for scheduling UEs, UE behaviors, signal/data flow etc. may be used.

There are different alternatives for distinguishing between these two types of TB-based UC transmission. In some embodiments, using different RNTIs for PDCCH scrambling are used to distinguish between split TB transmission and duplicate TB transmission. For example, a PDCCH scheduling split TB transmission can use a first new UE RNTI-1 for scrambling. Both or either one of bit-level scrambling and PDCCH CRC scrambling based on UE RNTI-1 can be applied. A PDCCH scheduling TB duplicate transmission can use a second new UE RNTI-2 for scrambling. Both or either one of bit-level scrambling and PDCCH CRC scrambling on UE RNTI-2 can be applied.

For the SUE, both RNTI-1 and RNTI-2 could be configured to distinguish between TB-split and TB duplicate type of UC transmission. When the SUE receives a PDCCH scrambled with RNTI-1, it knows to use split TB transmission, and so it conveys a different TB to the CUE. When the SUE receives a PDCCH scrambled with RNTI-2, it knows to use duplicate TB transmission, and so it conveys the same TB to the CUE. When the UE functioning as a SUE transmits normal traffic, it can use its normal RNTI for that; if the same UE can also function as a CUE to help with another SUE for its UC transmission, the UE may be assigned with a third RNTI for scrambling corresponding PDCCH.

For a UE functioning as a CUE, only one extra RNTI is configured for UC transmission as it may not need to distinguish between TB-split or TB-duplicate UC transmission; rather, the CUE simply transmits the TB conveyed to it by the SUE which may be a duplicate or a different TB of the TB transmitted by SUE itself.

In some embodiments, a single new RNTI is used in place of both new RNTI-1 and RNTI-2 for the SUE, where distinguishing between TB-split and TB duplicate UC transmission is achieved by other means, for example configured by high-layer signaling.

The same or different new RNTI could be configured for both SUE and CUE for UC transmission. This can, for example, be referred in general as UC-RNTI.

If a common PDCCH is used for scheduling UC data transmission for both SUE and CUE, two new common RNTI(s) like group RNTI can be configured and used for scrambling the common PDCCH(s), one for scheduling TB-split UE transmission and one for scheduling TB-split UE transmission. If separate PDCCH is used for scheduling UC transmission for SUE and CUE respectively, separate sets of new RNTI(s) could be configured for SUE and CUE respectively and used for scrambling PDCCHs for SUE and CUE to schedule TB-split or TB-duplicate UC transmission respectively. Such new RNTIs can also be used to determine the locations of PDCCH(s) scheduling UC traffic in the corresponding control resource set CORESET(s).

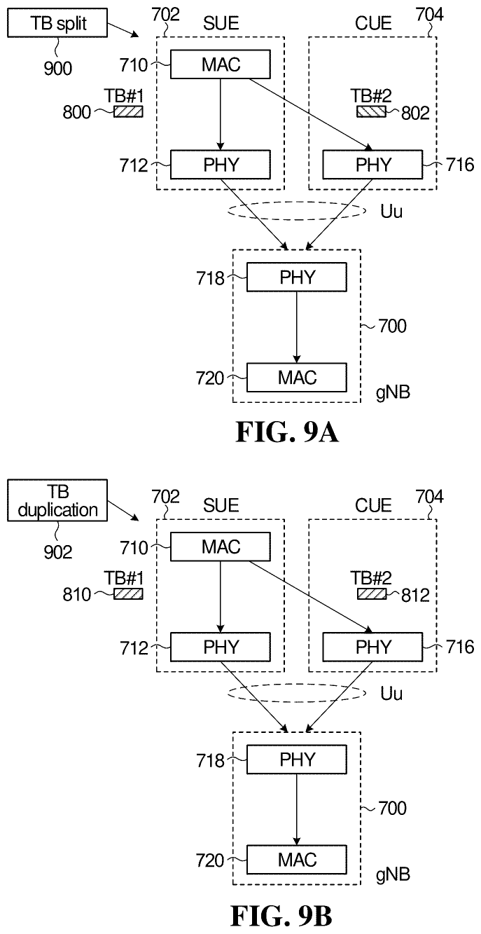

In some embodiments, higher layer signalling is used to configure TB-duplicate and TB-split UC data transmission. For example, a radio resource control (RRC) signal, or a medium access control (MAC) control entity (CE) signal could be used. In some embodiments, the high-layer configuration is sent to the SUE only, as the CUE may not need to distinguish TB-split or TB-duplicate UC transmission. An example is shown in FIG. 9A where higher layer signalling 900 is used to indicate TB-split UC data transmission. An example is shown in FIG. 9B where higher layer signalling 902 is used to indicate TB-duplicate UC data transmission.

Common and separate PDCCH are discussed above. The actual scheduling information is contained in DCI(s) transmitted using such common or separate PDCCH. Several alternatives for the contents of DCI used for scheduling UC transmission are provided. In a first alternative, if TB-duplicate UC transmission is configured, the DCI to the SUE will contain scheduling information for a single TB, otherwise if TB-split UC transmission is configured, the DCI to the SUE will contain scheduling information for 2 TBs. The scheduling information for a first of the two TBs is used for a transmission of a first TB by the SUE. The scheduling information for a second of the two TBs is used for SUE to prepare a TB to convey to the CUE for transmission. The scheduling information for a second of the two TBs can be used to determine the amount of data to convey from the SUE to CUE. In this manner, the format of the scheduling information can be the same for the first and second TB even though the second TB is not being scheduled for transmission by the SUE. In the example, a second TB is conveyed to the CUE. More generally, for inter-UE data transmission for this example/embodiment and other examples/embodiments described herein, it may not be necessary to convey a complete TB to the CUE. For example, in some embodiments, only the data for transmission by the CUE is conveyed to the CUE.

In a second alternative, the DCI to the SUE contains scheduling information only for one TB, and if TB-split is configured, data for a second TB with the same size of the one TB will be prepared and dispatched to CUE.

In a third alternative, the DCI to the SUE always contains scheduling information for two TBs, and if TB-duplicate is configured, the second TB has the same size as the first TB and the SUE prepares a duplicate TB and dispatches this to the CUE. Otherwise, if TB-split is configured, the second TB could have different size compared to that of the first TB. The SUE prepares two TBs, one for its own transmission and another for dispatch to the CUE.

In some embodiments, one of the two types of TB-based UC transmission (split and duplicate) is implicitly indicated in the DCI to the SUE.

In a first example of this approach, if DCI(s) sent to the SUE contains scheduling for a single TB (or a single codeword (CW), where typically a TB is encoded into one CW) this is used to imply/indicate TB duplicate UC transmission and the same TB will be duplicated and transmitted by both SUE and CUE. In this case, the scheduling part for a second TB may be filled with padding bits or zeros for easy detection. On the other hand, if DCI(s) sent to SUE contain scheduling information for two TBs, this is used to imply/indicate TB split UC transmission and in this case different TBs will be prepared by the SUE, one for transmission by the SUE itself and one for being conveyed to the CUE for transmission by the CUE. The UE can implicitly determine whether it is TB-duplicate or TB-split UC transmission by detecting whether the DCI contains scheduling information for one TB or two TB(s).

In this case, the DCI size is fixed regardless of whether TB-split or TB-duplicate UC transmission is scheduled.

In some embodiments, the TB size for each TB is derived from an assigned time-frequency resource and corresponding MCS indicated for each TB.

In a second example of this approach, if DCI(s) sent to the SUE contains scheduling for two TBs and such scheduling information are the same (e.g., MCS, HARQ ID, RV for each TB are the same), this is used to imply/indicate TB duplicate UC transmission and the same TB will be duplicated and transmitted by both SUE and CUE respectively. On the other hand, if DCI(s) sent to the SUE contain scheduling information for two TBs and such scheduling information are different (e.g., MCS, HARQ ID, RV for each TB are different), this is used to imply/indicate TB split UC transmission in which case different TBs will be prepared and transmitted by the SUE and CUE respectively. The UE can implicitly determine whether it is TB-duplicate or TB-split UC transmission by detecting scheduling information for both TB(s) and ascertaining whether it is the same (TB-duplicate) or different (TB-split).

In either case, the DCI size could be based on scheduling two TB transmission, thus the DCI size is fixed regardless of whether TB-split or TB-duplicate UC transmission is scheduled. Again, the TB size could be derived from assigned time-frequency (T-F) resource and MCS indicated for each TB.

### Detailed DCI Design Options for Tb-Based Uc Transmission

In a first alternative, a same DCI (common DCI) containing the scheduling information for two TB(s) can be used (for both SUE and CUE). The common PDCCH carrying such DCI could be transmitted from a shared/same resource (e.g., a shared control resource set (CORESET) with shared search space) or separate resource (e.g., separate CORESET(s) and separate search space) configured for SUE and CUE respectively. In this case, a same new RNTI (different from the conventional C-RNTI) could be configured and used to scrambling CRC of the common DCI.

In some embodiments, a common DCI carried by the common PDCCH contains one common set of time-frequency resources for both SUE and CUE transmission. This implies overlapping transmissions by the SUE and the CUE on the same time-frequency resource.

The common DCI may contain one or more HARQ process numbers (HARQ ID) and corresponding redundancy version (RV) (one HARQ ID and/or one RV for each TB). For TB duplication, one HARQ process is used and thus one HARQ ID and one or more RV is indicated for the same TB transmitted via different UE (SUE or CUE). For TB split, more than one HARQ processes are used, one for each TB. Therefore, more than one HARQ ID and their corresponding RV are indicated in the common DCI, one for each TB. Alternatively, a first HARQ ID can be indicated while the other HARQ ID can be derived from the first HARQ ID, for example the second HARQ ID=first HARQ ID+offset. In a specific example of this approach, second HARQ ID=first HARD ID+1, third HARQ ID=first HARQ ID+2 and so on.

The common DCI may contain one or more NDI, one for each TB, indicating whether it is a new transmission or a retransmission.

For data duplication, one NDI is used. If NDI is toggled, new data is transmitted from both SUE and CUE. If NDI is not toggled, then both SUE and CUE perform retransmission for the same old TB.

For data split, two NDI can be indicated (more generally one NDI for the SUE and one NDI for each CUE). In this case, the NDI for the SUE indicates whether the TB being transmitted by the SUE is new or a retransmission, and the NDI for each CUE indicates whether the TB being transmitted by the CUE is new or a retransmission. In this manner, new transmissions and re-transmissions by the SUE and CUE can be scheduled independently.

In some embodiments, the DCI includes demodulation reference symbol (DMRS) indication(s) for decoding PUSCH(s) carrying two TBs (or two CW), one for each UE.

For this embodiment, the SUE uses the scheduling information for one or both TB(s) to prepare the data for transmission by itself or via the CUE. The CUE uses the scheduling information for one TB (e.g., the 2nd TB) to transmit the data.

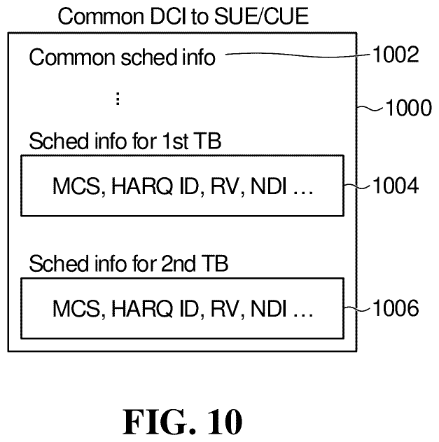

FIG. 10 shows an example of a common PDCCH carrying a common DCI 1000 for scheduling 2 TBs (max e.g. maximum 2CW) transmission. A DCI format similar to DCI format 1-1 in NR may be used. The common DCI 1000 includes common scheduling information 1002 applicable to scheduling both TBs to avoid duplication which may include resource allocation etc, and scheduling information 1004 specific for the first TB (including, for example, one or more of MCS, HARQ ID, RV. NDI), and scheduling information 1006 specific for the second TB.

If TB duplication is scheduled, in addition to the common scheduling information 1002, the DCI includes the scheduling information 1004 specific to first TB while the scheduling information (or part/field) 1006 part specific for to the 2nd TB is filled with padding bits or zeros. If TB split is scheduled, scheduling information 1004,1006 for two TBs is included.

In this case, data duplicate or data split can be implicitly signaled to the SUE by the inclusion of scheduling information for only one TB (e.g., the 1st TB) or by inclusion of scheduling information for both the first and second TBs.

The TB size for each TB may be derived from the assigned T-F resource and corresponding MCS indicated for each TB. The SUE and CUE will transmit their respective UC transmission on the same T-F resource as scheduled by the common DCI in the common scheduling information field. For TB-split, two TB(s) transmitted by SUE and CUE respectively could have different TB size.

In some embodiments, scheduling of transmission of the second TB from the SUE to the CUE is not specified if a non-3GPP inter-UE link is assumed. However, if a 3GPP specified interface is used for the inter-UE link, a resource can be configured on the inter-UE link to transmit the second TB from the SUE to the CUE. For example, configured grant (CG) can be used to configure some resource on the inter-UE link if a PC5 link is used to carry the second TB from SUE to CUE. Such scheduling information for the inter-UE link does not need to be carried by the common DCI.

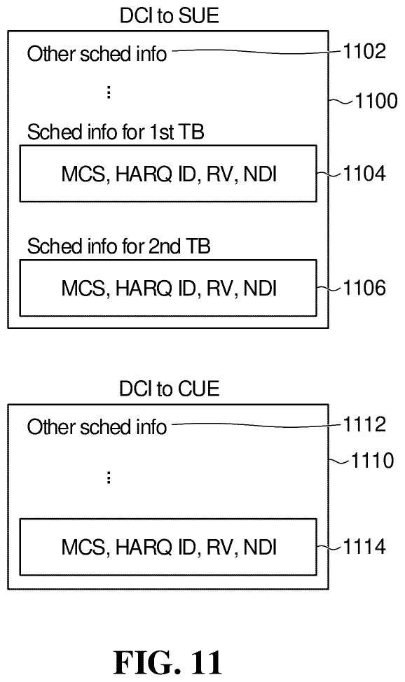

In some embodiments, separate PDCCH(s) for SUE and CUE are used, they could be transmitted from separate CORESET(s) configured for SUE or CUE respectively. An example is shown in FIG. 11. FIG. 11 shows a first DCI (transmitted on a first PDCCH) 1100 for the SUE. This DCI contains other scheduling information 1102 common to both the first and second TB, and scheduling information 1104 specific for the first TB and scheduling information 1106 specific for the second TB. Also shown is a second DCI (transmitted on a second PDCCH) 1110 for the CUE which contains scheduling information 1114 specific for the TB it conveys for the SUE and some other scheduling information 1112.

The PDCCH for SUE may contain scheduling information for two TB(s) and is used to schedule UC transmission from the SUE to the gNB. It is also used to prepare new TB(s) for CUE transmission following the same principle as mentioned for the common PDCCH.

For the TB-split case, the scheduling information can be used to indicate the TB size for the second TB. To be more specific, a scheduling field specific to the second TB can be reused to carry the TB size of the second TB directly. Alternatively, it can be reused to carry other relevant information that can be used to derive the TB size of the second TB. For example, specific fields to carry MCS, HARQ ID and RV for the second TB as shown in FIG. 10 can be used to carry second TB size or other relevant information that can be used to derive that.

Similar to the common PDCCH case, the scheduling of second TB from SUE to CUE is not specified if a non-3GPP inter-UE link is employed. However, if a 3GPP specified interface is used for inter-UE link, some resource can be configured on the inter-UE link to transmit the second TB from SUE to the CUE. For example, configured grant (CG) can be used to configure some resource on the inter-UE link if PC5 link is used to carry the second TB from SUE to CUE, thus such scheduling information for inter-UE link does not need to be carried by the PDCCH to the SUE.

In some embodiments, the PDCCH for the CUE contains scheduling information for one TB and is used to schedule UC transmission from the CUE to the gNB.

In some embodiments, the HARQ ID shall be consistent in respective PDCCH (or DCI) for the SUE and the CUE. For example, if data is duplicated, the same HARQ ID may be used in the PDCCH for the SUE and in the PDCCH. Different RVs may be used for the SUE and the CUE transmission. If data is split, the same HARQ ID may be used in both the PDCCH for the SUE and the PDCCH for the CUE for the TB that is dispatched and transmitted via CUE to the gNB. Thus, the HARQ ID for the TB transmitted via CUE is consistent across the SUE, CUE and gNB. For example, the HARQ ID for the 2nd TB in PDCCH for SUE shall be the same as HARQ ID in PDCCH for CUE.

The HARQ ID and RV received/decoded by SUE for UC transmission by the CUE could be conveyed to the CUE and if there exists some discrepancy between the HARQ ID and/or RV received by SUE and those received by CUE, the CUE could ignore the scheduling and skip the UC (re-)transmission. Alternatively, the CUE could follow the HARQ ID and RV conveyed from the SUE for its part of UC transmission.

In some embodiments, the NDI in respective PDCCH (or DCI) for SUE and CUE shall be consistent. For example, if data is duplicated, the NDI can be toggled together in both PDCCH for SUE and CUE respectively such that both SUE and CUE will transmit new TB (data).

If NDI in a DCI for the CUE is toggled meaning new data transmission, while the TB buffer is not updated (flushed with new data), the CUE may skip/ignore the scheduling for UC transmission because the new TB may not be prepared and/or received by the CUE correctly in time.

If NDI in a DCI for the CUE is not toggled meaning re-transmission for old data, while the TB buffer is updated (flushed), the CUE may ignore new data in the TB buffer and continue with the re-transmission of old data (TB). Alternatively, it may use the new data received in TB buffer and transmit them to the gNB. In some embodiments, the side information such as HARQ ID/RV/NDI received by SUE for the UC transmission via CUE could be conveyed via inter-UE link along with data, that could help CUE with verification between the scheduling information it receives and that received by SUE respectively.

### UE Behavior for TB-Based UC Transmission

In this embodiment, different UE methods or behaviors for implementing for TB-based UC transmission are provided. Functionality will be described for SUE and CUE respectively. Of course, a given UE can be configured to function as SUE for some transmissions, and/or CUE for other transmissions.

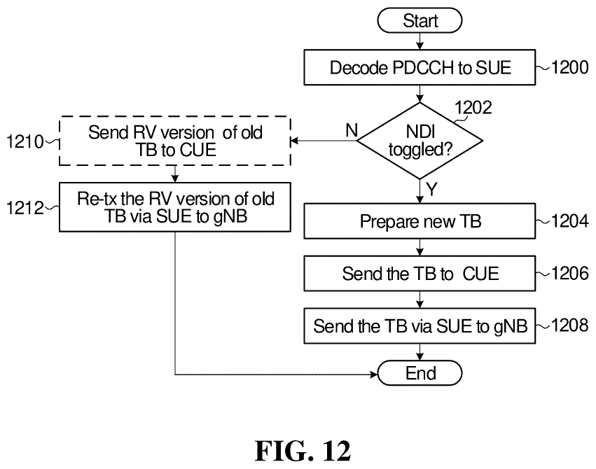

FIG. 12 is a flowchart of an example of a method for execution by a UE acting as a SUE, featuring TB duplication. The method begins in block 1200 with receiving and decoding a PDCCH that schedules a UC transmission with TB duplication. If it is new data (NDI is toggled), yes path block 1202, then in block 1204, the SUE prepares a new (the same) TB for both SUE and CUE. The TB size may be derived from scheduling resource and MCS. At block 1206, the SUE dispatches the TB to the CUE via inter-UE connection. The old TB in CUE TB buffer is flushed (emptied). Then at block 1208, the SUE transmits the TB to the gNB according to scheduling information in DCI (such as HARQ ID and RV).

If NDI is not toggled (no path block 1202) meaning it is old data to be sent (re-transmitted), there is no need for SUE to prepare a new TB. Optionally at block 1210, the SUE transmits an RV of the old TB via inter-UE link to the CUE for the CUE to transmit that RV to the gNB. At block 1212, the SUE re-transmits the RV of the old TB to the gNB according to scheduling information in the DCI (such as HARQ ID and RV).

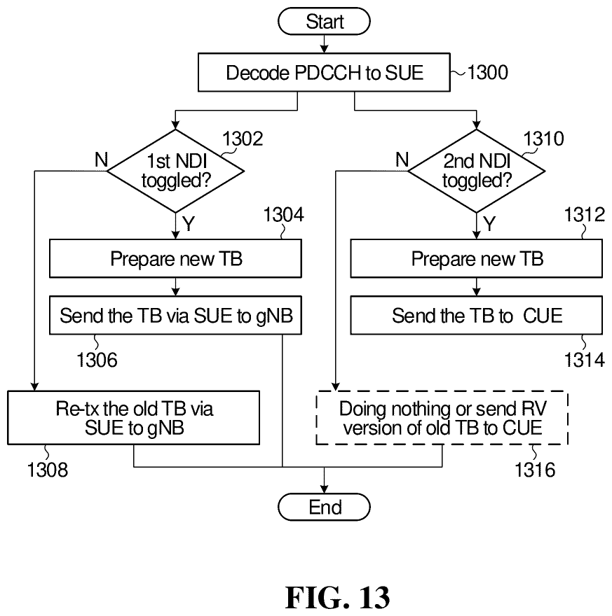

FIG. 13 is a flowchart of an example of a method for execution by a UE acting as a SUE, featuring TB split. The method begins in block 1300 with receiving and decoding a PDCCH that schedules a UC transmission with TB split. The DCI carried by the PDCCH contain two sets of MCS, NDI, HARQ, RV (like scheduling of two CW or two TB). Both DCI are processed by the SUE and the order is immaterial.

If it is new data for the first TB (NDI is toggled), (yes path block 1302), then in block 1304, the SUE prepares a new TB for transmission by SUE. At block 1306, the SUE transmits the TB to the gNB according to the first set of scheduling information in DCI (such as HARQ ID and RV). The TB size may be derived from common scheduling resource and corresponding MCS. If the first NDI is not toggled (no path block 1302) then at block 1308, the SUE re-transmits the RV of the old TB to the gNB according to the first set of scheduling information in the DCI (such as HARQ ID and RV).

If the second NDI is toggled (yes path block 1310), then at block 1312 the SUE prepares a new TB for the CUE and at block 1314 the SUE dispatches this to the CUE via inter-UE link. The TB size is derived from common scheduling resource and corresponding MCS. If the second NDI is not toggled (no path block 1310, then the SUE could do nothing as indicated at 1316, and the CUE will retransmit the old TB(s). The old TB(s) have already dispatched and received by CUE and stored in CUE in certain format. The CUE will conduct re-transmission using stored data from the corresponding HARQ buffer (or circular buffer after channel encoder). Alternatively, the RV of the old TB can be sent from the SUE to the CUE for the CUE to transmit to the gNB, in which case the CUE does not need to generate its own RV version of the old TB.

As mentioned previously, the inter-UE connection may not be specified by 3GPP. This connection could be a wired or wireless connection such as WiFi, Bluetooth, Ethernet connection etc.

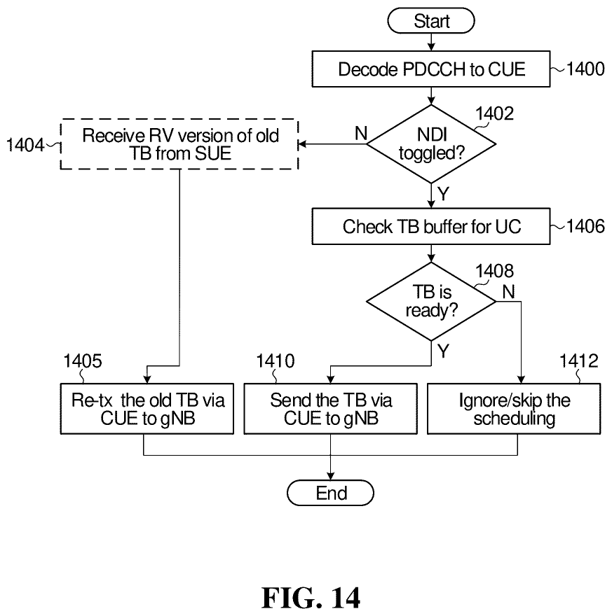

FIG. 14 is a flowchart of an example of a method for execution by a UE acting as a CUE. The method begins in block 1400 with receiving and decoding PDCCH scheduling a UC transmission. If NDI is toggled (yes path block 1402), this means that there is new data to be transmitted. At block 1406, the CUE checks the data buffer (or TB buffer) containing data from the SUE to see if the TB from the SUE is received/available. If a TB is ready, from the yes path of block 1408, then in block 1410 the CUE prepares and transmits the TB to gNB according to scheduling information in the DCI. An inter-UE transmission used to convey the TB from the SUE to the CUE may involve the whole TB being assembled in the SUE and then being processed and transmitted as a whole TB to the CUE. Alternatively, the SUE may send the data as smaller packets (portions) of the TB to the CUE in which case the CUE assembles them to form a TB for transmission. If no TB is ready, following no path of block 1408, then the scheduling is ignored/skipped as indicated at block 1412.

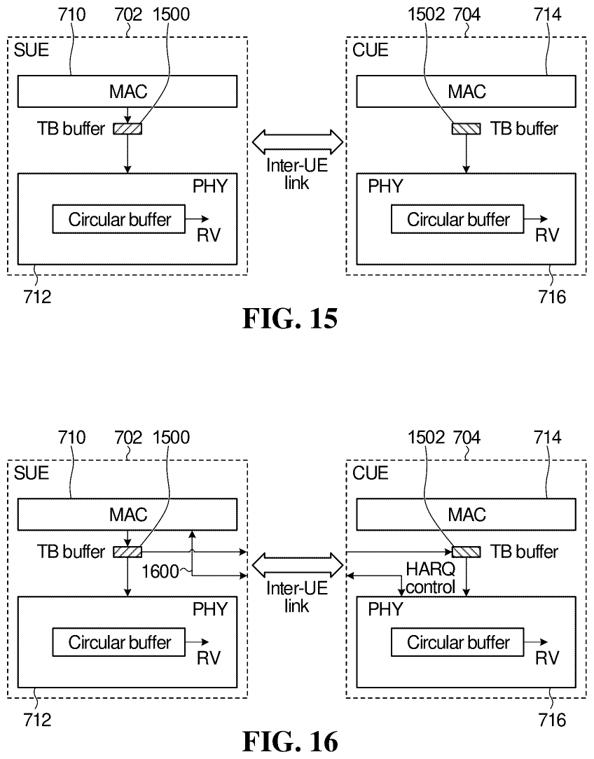

If the NDI is not toggled, following no path of block 1402, then in block 1405, the CUE will perform a re-transmission of an old TB to the gNB according to HARQ ID and RV in DCI. The re-transmission of the old TB could mean the re-transmission of an RV of the old TB (a redundancy version of the data in a circular buffer), which is generated by the old TB (previous TB) after the channel encoder and is stored in a circular buffer of 716 in CUE (i.e., HARQ buffer) as shown in FIG. 15. Alternatively, this RV version of the old TB can be passed from the SUE to CUE for the CUE to transmit to the gNB as indicated by block 1404, in which case there is no need for the CUE to generate the TB by itself for re-transmission. FIG. 15 is a more detailed version of the SUE and CUE of FIG. 7, showing TB buffers of 1500,1502 and circular buffers of 712,716 for SUE and CUE respectively. In this figure, TB buffers 1500 and 1502 are used by SUE and CUE to store TB data and exchange such data between them via inter-UE links. The circular buffers of 712 and 716 are conventional circular buffers in SUE and CUE respectively to store data after channel encoder in PHY and use them for HARQ (re-)transmission. For UC transmission from CUE, the circular buffer on UC could store data for re-transmission already.

For UC transmission in the uplink, in some embodiments, the HARQ entity managing UC transmission is configured in the MAC layer of the SUE. Various alternatives for the HARQ control for UC transmission at the CUE will now be described.

In a first alternative, shown in FIG. 16 which shows like numbering from FIGS. 7 and 15, the HARQ control for the CUE is done in a HARQ entity configured in the SUE MAC layer 710. In this case, the HARQ information decoded from the DCI such as HARQ ID, RV and NDI for the CUE is passed to SUE MAC layer 710 and the HARQ transmission decision is sent at 1600 from the SUE MAC layer 710 to the PHY layer 716 of the CUE to instruct HARQ (re-)transmission.

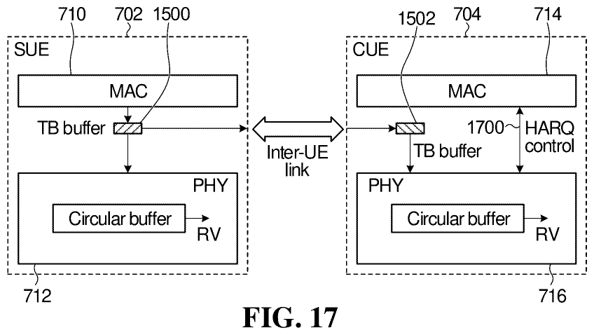

In a second alternative, shown in FIG. 17, which again shows like numbering from FIGS. 7 and 15, the HARQ control for the CUE is done with assistance from the MAC layer 714 in the CUE. In this case, some HARQ entity functionality for UC (re-HWC transmission is configured and implemented in the MAC layer 714 of the CUE. The HARQ information decoded from the DCI at the CUE could be passed to the MAC layer 714 of the CUE and the MAC layer 714 then makes a decision for HARQ operation and conveys this to the HARQ layer at 716. For example, if HARQ information decoded from the DCI indicates a re-transmission of an earlier transmission, the MAC layer of the CUE could instruct its PHY layer to transmit a corresponding RV version from its circular buffer (i.e., HARQ buffer) after a channel encoding operation. Otherwise, if the HARQ information such as NDI indicates it is a new TB, the MAC layer of the CUE could wait for SUE to send the new TB and prepare for its transmission.

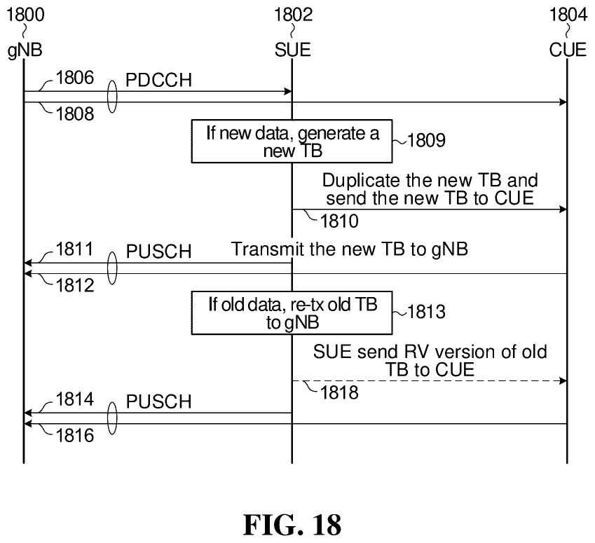

FIG. 18 shows a signal/data flow example for a duplicate TB procedure between gNB 1800, SUE 1802, and CUE 1804. The example begins with the transmission of PDCCH at 1806,1808. This could be a common PDCCH or separate PDCCH as described above. If new data needs to be transmitted, then the SUE 1802 generates a new TB at 1809 and duplicates this and sends it to the CUE 1804 at 1810. At 1811, the SUE 1802 sends the new TB on the PUSCH to the gNB 1800, and similarly, at 1812, the CUE 1804 sends the new TB on the PUSCH to the gNB 1800. If the data to be sent is old data (as indicated at 1813), then the SUE 1802 and CUE 1804 transmit retransmissions of the old data at 1814,1816. In some embodiments, the SUE 1802 sends an RV of the old TB to the CUE 1804 at 1818 for it to transmit to the gNB 1800 at 1816.

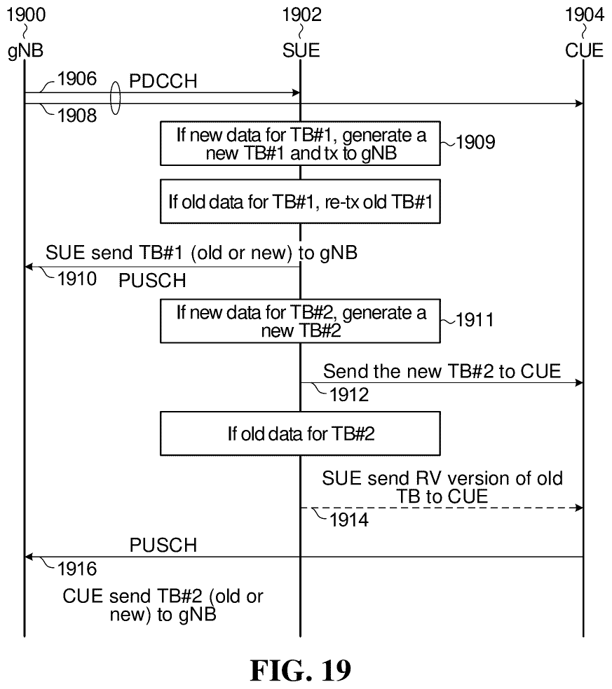

FIG. 19 shows a signal/data flow example for a split TB procedure between gNB 1900, SUE 1902, and CUE 1904. The example begins with the transmission of PDCCH at 1906,1908. This could be a common PDCCH or separate PDCCH as described above. If there is new data to be transmitted for the first TB, then the SUE 1902 generates a new TB at 1909. If there is old data to be re-transmitted for the first TB, then an old TB will be retransmitted. Transmission of a TB (old or new) by the SUE 1902 is indicated at 1910. If there is new data to be transmitted for the second TB, then the SUE 1902 generates a new second TB at 1911 and sends this to the CUE 1904 at 1912. If there is old data to be re-transmitted for the second TB, the SUE 1902 could send nothing to the CUE 1904, or alternatively it sends an RV of the old TB to the CUE 1904 as indicated at 1914. At 1916, the CUE 1904 transmits the second TB (old or new) to the gNB.

### Code Block Group (CBG) Based Re-Transmission for UC

In some embodiments, for handling large TB sizes, code block group (CBG) based HARQ is used to improve the efficiency and reduce the latency. With this approach, a TB is divided into a number of CBG(s). Each CBG consists of a number of CBs (code block).

The SUE or CUE attempts to transmit each CBG of a TB at its initial transmission. If a CBG is transmitted successfully but the whole TB transmission is not successful, the non-successfully transmitted CBG(s) would be re-transmitted. For a CBG based HARQ process, re-transmission is decided in the PHY layer based on an indication in the DCI, and as such there is no need to exchange information with the MAC layer. This would reduce the latency as well. The SUE and CUE conduct their own CBG based re-transmission until all the CBG(s) in the TB are decoded successfully.

To accelerate CBG based re-transmission when a TB is duplicated (the same TB is transmitted by both SUE and CUE), different CBG(s) re-transmission could be scheduled (or pre-configured) for each SUE and CUE respectively. For example, if a number of CBG(s) are not received successfully at the receiver (based on the combined results of transmissions from both SUE and CUE), some of the CBG(s) could be scheduled for re-transmission from SUE, while some other non-successful CBG(s) could be scheduled for re-transmission from the CUE. Such scheduling distribution of CBG based re-transmission could be determined by the gNB and indicated in DCI to the SUE and CUE respectively.

Such CBG based re-transmission distribution could be pre-configured as well, for example, even numbered CBG not successfully transmitted could be re-transmitted from the SUE while odd numbered CBG not successfully transmitted could be re-transmitted from CUE.

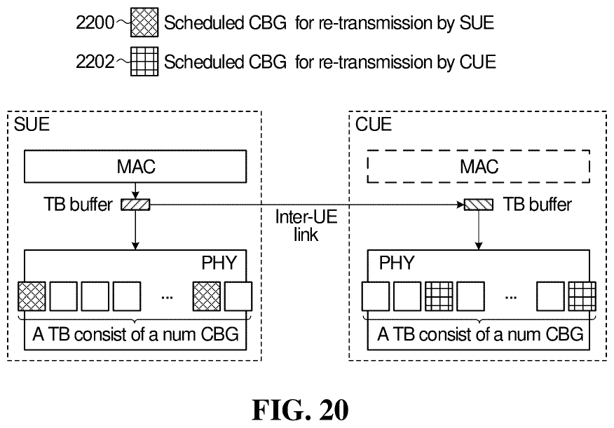

An example is shown in FIG. 20 where CBG scheduled for retransmission by the SUE are indicated at 2200, and CBG scheduled for retransmission by the CUE are indicated at 2202.

Various embodiments are disclosed by way of example herein.

These embodiments include, for example, a method that involves receiving a first PDCCH scheduling a joint UE transmission for data originated from a first UE, conveying data from the first UE to a second UE over an inter-UE connection for transmission by the second UE, and transmitting a first TB based on the first PDCCH. From the perspective of a transmitter such as a gNB or other type of network device, for example, a method may involve transmitting the first PDCCH scheduling the joint UE transmission for data originated from the first UE, receiving the first TB of data based on scheduling information in the first PDCCH from the first UE, and receiving the second TB of data from the second UE based on the data conveyed to the second UE from the first UE.

Apparatus embodiments disclosed herein include an apparatus with at least one processor coupled with a memory storing instructions. The instructions, when executed by the at least one processor, may cause a UE or a network device to execute a method. Such a method, in the context of causing a UE to execute the method, may involve receiving a first PDCCH scheduling a joint UE transmission for data originated from a first UE, conveying data from the first UE to a second UE over an inter-UE connection for transmission by the second UE, and transmitting a first TB based on the first PDCCH. In the context of causing a network device to execute a method, such a method may involve transmitting the first PDCCH scheduling the joint UE transmission for data originated from the first UE, receiving the first TB of data based on scheduling information in the first PDCCH from the first UE, and receiving the second TB of data from the second UE based on the data conveyed to the second UE from the first UE.

The first UE in these examples may be referred to herein as an SUE or a UE in an SUE role, and the second UE in these examples may be referred to herein as a CUE or a UE in a CUE role. The joint UE transmission in these examples may be referred to herein as a UC transmission. A gNB is used herein as an illustrative example of a network device.

These and other features herein should be interpreted accordingly. For example, any features disclosed herein in the context of an SUE (and/or TUE) or a UE in an SUE (and/or TUE) role apply more generally to a UE from which TB data that is to be transmitted is originated (or in the case of a TUE, a UE to which TB data is destined). Such a UE is the first UE in the examples above. Similarly, features disclosed herein in the context of a CUE or a UE in a CUE role apply more generally to a UE to which TB data that is originated from another UE and is to be transmitted is conveyed over an inter-UE connection (or in the case of downlink data, a UE from which TB data that is received is conveyed to a TUE over an inter-UE connection). Such a UE is the second UE in the examples above. Features that are disclosed herein in the context of network, network-side, or gNB features, for example, apply more generally to network devices.

Please note that the different embodiments may be implemented separately or combined. Although a combination of features is shown in the illustrated embodiments, not all of them need to be combined to realize the benefits of various embodiments of this disclosure. In other words, a system or method designed according to an embodiment of this disclosure will not necessarily include all of the features (including steps) shown in any one of the Figures or all of the portions schematically shown in the Figures. Moreover, selected features of one example embodiment may be combined with selected features of other example embodiments.

Numerous modifications and variations of the present disclosure are possible in light of the above teachings. It is therefore to be understood that within the scope of the appended claims, the disclosure may be practiced otherwise than as specifically described herein.

For instance, the present disclosure encompasses the following examples, and others.

According to an example 1, a method in a first UE comprises: receiving a first PDCCH scheduling a UC transmission for the first UE in an SUE role; conveying data to a second UE in a CUE role over an inter-UE connection for transmission by the second UE; transmitting a first TB based on the first PDCCH.

An example 2 relates to the method of example 1 wherein: when the UC transmission is a TB duplicate UC transmission, the data is a duplicate of the first TB, or the data can be used to generate the first TB; when the UC transmission is a TB split UC transmission, the data is a second TB different than the first TB, or the data can be used to generate the second TB.

An example 3 relates to the method of example 2 wherein: the first PDCCH includes an indication of whether the UC transmission is to be the TB duplicate UC transmission or the TB split UC transmission.

An example 4 relates to the method of example 2 further comprising: receiving higher layer signalling to indicate whether the UC transmission is the TB duplicate UC transmission or the TB split UC transmission.

An example 5 relates to the method of example 2 wherein: the first PDCCH contains scheduling information for only the first TB to indicate that the TB duplicate UC transmission is being scheduled; or the first PDCCH contains scheduling information for the first TB and the second TB to indicate that the TB split UC transmission is being scheduled.

An example 6 relates to the method of example 2 wherein: the first PDCCH contains scheduling information for two TBs and in a case where the scheduling information for the two TBs is the same, the TB duplicate UC transmission is being scheduled, and in a case where the scheduling information for the two TBs is different, the TB split UC transmission is being scheduled.

An example 7 relates to the method of example 2 wherein the first PDCCH is scrambled with a first RNTI to indicate the TB duplicate UC transmission and the first PDCCH is scrambled with a second RNTI to indicate the TB split UC transmission.

An example 8 relates to the method of any one of examples 1 to 7, further comprising: receiving a second PDCCH scheduling a transmission of normal UE transmission; wherein the first PDCCH is scrambled with a first RNTI to indicate that the first PDCCH is scheduling UC transmission and the second PDCCH is scrambled with a second RNTI to indicate that the second PDCCH is scheduling the normal UE transmission.

An example 9 relates to the method of any one of examples 2 to 7, wherein: for the TB duplicate UC transmission, the first PDCCH contains an NDI indicating whether a new transmission is being scheduled or a retransmission is being scheduled.

An example 10 relates to the method of any one of examples 2 to 7, wherein: for the TB split UC transmission, the first PDCCH contains a first NDI indicating whether a new transmission or a retransmission is being scheduled for transmission by the first UE, and contains a second NDI indicating whether a new transmission or a retransmission is being scheduled for transmission by the second UE in the CUE role.

According to an example 11, an apparatus in a UE comprises at least one processor coupled with a memory storing instructions, wherein when the instructions executed by the at least one processor, cause the UE to execute a method comprising: receiving a first PDCCH scheduling a UC transmission for the UE in an SUE role; conveying data to a second UE in a CUE role over an inter-UE connection for transmission by the second UE; transmitting a first TB based on the PDCCH.

An example 12 relates to the apparatus of example 11 wherein: when the UC transmission is a TB duplicate UC transmission, the data is a duplicate of the first TB, or data can be used to generate the first TB; when the UC transmission is a TB split UC transmission, the data is a second TB different than the first TB, or the data can be used to generate the second TB.

An example 13 relates to the apparatus of example 12 wherein: the first PDCCH includes an indication of whether the UC transmission is to be the TB duplicate UC transmission or the TB split UC transmission.

An example 14 relates to the apparatus of example 12, the method further comprising: receiving higher layer signalling to indicate whether the UC transmission is the TB duplicate UC transmission or the TB split UC transmission.

An example 15 relates to the apparatus of example 12 wherein: the first PDCCH contains scheduling information for only the first TB to indicate the TB duplicate UC transmission is being scheduled; the first PDCCH contains scheduling information for the first TB and the second TB to indicate the TB split UC transmission is being scheduled.

An example 16 relates to the apparatus of example 12 wherein: the first PDCCH contains scheduling information for two TBs and in a case where the scheduling information for the two TBs is the same, the TB duplicate UC transmission is being scheduled, and in a case where the scheduling information for the two TBs is different, the TB split UC transmission is being scheduled.

An example 17 relates to the apparatus of example 12 wherein the first PDCCH is scrambled with a first RNTI to indicate the TB duplicate UC transmission and the first PDCCH is scrambled with a second RNTI to indicate the TB split UC transmission.

An example 18 relates to the apparatus of example 11, the method further comprising: receiving a second PDCCH scheduling a transmission of normal UE transmission; the second PDCCH is scrambled with a second RNTI to indicate the normal UE transmission.

An example 19 relates to the apparatus of any one of examples 12 to 17, wherein: for the TB duplicate UC transmission, the first PDCCH contains an NDI indicating whether a new transmission is being scheduled or a retransmission is being scheduled.

An example 20 relates to the apparatus of any one of examples 12 to 17, wherein: for the TB split UC transmission, the first PDCCH contains a first NDI indicating whether a new transmission or a retransmission is being scheduled for transmission by the first UE, and contains a second NDI indicating whether a new transmission or a retransmission is being scheduled for transmission by the second UE in the CUE role.

According to an example 21, a method in a network device comprises: transmitting a first PDCCH scheduling a UC transmission for a first UE in an SUE role; receiving a first TB based on scheduling information in the PDCCH from the first UE; receiving a second TB from a second UE in a CUE role based on data conveyed to the second UE by the first UE.

An example 22 relates to the method of example 21 wherein: when the UC transmission is a TB duplicate UC transmission, the second TB is a duplicate of the first TB; when the UC transmission is a TB split UC transmission, the second TB is different than the first TB.

An example 23 relates to the method of example 22 wherein: the first PDCCH includes an indication of whether the UC transmission is to be the TB duplicate UC transmission or the TB split UC transmission.

An example 24 relates to the method of example 22 further comprising: transmitting higher layer signalling to indicate whether the UC transmission is the TB duplicate UC transmission or the TB split UC transmission.

An example 25 relates to the method of example 22 wherein: the first PDCCH contains scheduling information for only the first TB to indicate that the TB duplicate UC transmission is being scheduled; the first PDCCH contains scheduling information for the first TB and a second TB to indicate that the TB split UC transmission is being scheduled.

An example 26 relates to the method of example 22 wherein: the first PDCCH contains scheduling information for two TBs and in a case where the scheduling information for the two TBs is the same, the duplicate TB UC transmission is being scheduled, and in a case where the scheduling information for the two TBs is different, the split TB UC transmission is being scheduled.

An example 27 relates to the method of example 22 wherein the first PDCCH is scrambled with a first RNTI to indicate the TB duplicate UC transmission and the first PDCCH is scrambled with a second RNTI to indicate the TB split UC transmission.

An example 28 relates to the method of any one of examples 22 to 27, further comprising: transmitting a second PDCCH scheduling a transmission of normal UE transmission; wherein the first PDCCH is scrambled with a first RNTI to indicate that the first PDCCH is scheduling UC transmission and the second PDCCH is scrambled with a second RNTI to indicate that the second PDCCH is scheduling the normal UE transmission.

An example 29 relates to the method of any one of examples 22 to 27, wherein: for the TB duplicate UC transmission, the first PDCCH contains an NDI indicating whether a new transmission is being scheduled or a retransmission is being scheduled.

An example 30 relates to the method of any one of examples 22 to 27, wherein: for the TB split UC transmission, the first PDCCH contains a first NDI indicating whether a new transmission or a retransmission is being scheduled for transmission by the first UE, and contains a second NDI indicating whether a new transmission or a retransmission is being scheduled for transmission by the second UE in the CUE role.

According to an example 31, an apparatus in a network device comprises at least one processor coupled with a memory storing instructions, wherein when the instructions executed by the at least one processor, cause the network device to execute a method comprising: transmitting a first PDCCH scheduling a UC transmission for a first UE in a source UE role; receiving a first TB based on the first PDCCH from the first UE; receiving a second TB from a second UE in a cooperative UE role based on data conveyed to the second UE by the first UE.

An example 32 relates to the apparatus of example 31 wherein: when the UC transmission is a TB duplicate UC transmission, the second TB is a duplicate of the first TB; when the UC transmission is a TB split UC transmission, the second TB is different than the first TB.

An example 33 relates to the apparatus of example 32 wherein: the first PDCCH includes an indication of whether the UC transmission is to be the TB duplicate UC transmission or the TB split UC transmission.

An example 34 relates to the apparatus of example 32 further comprising: transmitting higher layer signalling to indicate whether the UC transmission is the TB duplicate UC transmission or a TB split UC transmission.

An example 35 relates to the apparatus of example 32 wherein: the first PDCCH contains scheduling information for only the first TB to indicate that TB duplicate UC transmission is being scheduled; the first PDCCH contains scheduling information for the first TB and a second TB to indicate that TB split UC transmission is being scheduled.

An example 36 relates to the apparatus of example 32 wherein: the first PDCCH contains scheduling information for two TBs and in a case where the scheduling information for the two TBs is the same, the duplicate TB UC transmission is being scheduled, and in a case where the scheduling information for the two TBs is different, the split TB UC transmission is being scheduled.

An example 37 relates to the apparatus of example 32 wherein the first PDCCH is scrambled with a first RNTI to indicate the TB duplicate UC transmission and the first PDCCH is scrambled with a second RNTI to indicate the TB split UC transmission.

An example 38 relates to the apparatus of any one of examples 31 to 37 further comprising: transmitting a second PDCCH scheduling a transmission of normal UE transmission; wherein the first PDCCH is scrambled with a first RNTI to indicate that the first PDCCH is scheduling UC transmission and the second PDCCH is scrambled with a second RNTI to indicate that the second PDCCH is scheduling the normal UE transmission.

An example 39 relates to the apparatus of any one of examples 32 to 37 wherein: for the TB duplicate UC transmission, the first PDCCH contains an NDI indicating whether a new transmission is being scheduled or a retransmission is being scheduled.

An example 40 relates to the apparatus of any one of examples 32 to 37 wherein: for the TB split UC transmission, the first PDCCH contains a first NDI indicating whether a new transmission or a retransmission is being scheduled for transmission by the first UE, and contains a second NDI indicating whether a new transmission or a retransmission is being scheduled for transmission by the second UE in the CUE role.

What is claimed is:

1. A method comprising:
receiving a first physical downlink control channel (PDCCH) scheduling a joint user equipment (UE) transmission for data originated from a first UE;
conveying data from the first UE to a second UE over an inter-UE connection for transmission by the second UE; and
transmitting a first transport block (TB) based on the first PDCCH.

2. The method of claim 1 wherein:
when the joint UE transmission is a TB duplicate joint UE transmission, the data is a duplicate of the first TB, or the data is used to generate the first TB; or
when the joint UE transmission is a TB split joint UE transmission, the data is a second TB different than the first TB, or the data is used to generate the second TB.

3. The method of claim 2 wherein:
the first PDCCH includes an indication of whether the joint UE transmission is to be the TB duplicate joint UE transmission or the TB split joint UE transmission.

4. The method of claim 2 further comprising:
receiving higher layer signalling indicating whether the joint UE transmission is the TB duplicate joint UE transmission or the TB split joint UE transmission.

5. The method of claim 2 wherein:
the first PDCCH contains scheduling information for only the first TB indicating that the TB duplicate joint UE transmission is being scheduled; or
the first PDCCH contains scheduling information for the first TB and the second TB indicating that the TB split joint UE transmission is being scheduled.

6. The method of claim 2 wherein:
the first PDCCH contains scheduling information for two TBs, and in a case where the scheduling information for the two TBs is the same, the TB duplicate joint UE transmission is being scheduled, and in a case where the scheduling information for the two TBs is different, the TB split joint UE transmission is being scheduled.

7. The method of claim 2 wherein the first PDCCH being scrambled with a first radio network temporary identifier (RNTI) indicates the TB duplicate joint UE transmission or the first PDCCH being scrambled with a second RNTI indicates the TB split joint UE transmission.

8. The method of claim 1, further comprising:
receiving a second PDCCH scheduling a transmission of normal UE transmission;
wherein the first PDCCH is scrambled with a first radio network temporary identifier (RNTI) indicating that the first PDCCH is scheduling the joint UE transmission and the second PDCCH is scrambled with a second RNTI indicating that the second PDCCH is scheduling the normal UE transmission.

9. The method of claim 2, wherein:
for the TB duplicate joint UE transmission, the first PDCCH contains a new data indicator (NDI) indicating whether a new transmission is being scheduled or a retransmission is being scheduled.

10. The method of claim 2, wherein:
for the TB split joint UE transmission, the first PDCCH contains a first new data indicator (NDI) indicating whether a new transmission or a retransmission is being scheduled for transmission by the first UE, and contains a second new data indicator (NDI) indicating whether a new transmission or a retransmission is being scheduled for transmission by the second UE.

11. An apparatus comprising at least one processor coupled with memory storing instructions, wherein the instructions, when executed by the at least one processor, cause a user equipment (UE) to:
receive a first physical downlink control channel (PDCCH) scheduling a joint UE transmission for data originated from the UE;
convey data to a second UE over an inter-UE connection for transmission by the second UE; and
transmit a first transport block (TB) based on the first PDCCH.

12. A method comprising:
transmitting a first physical downlink control channel (PDCCH) scheduling a joint user equipment (UE) transmission for data originated from a first UE;
receiving a first transport block (TB) of data based on scheduling information in the first PDCCH from the first UE; and
receiving a second TB of data from a second UE based on data conveyed to the second UE from the first UE.

13. The method of claim 12 wherein:
when the joint UE transmission is a TB duplicate joint UE transmission, the second TB is a duplicate of the first TB; or
when the joint UE transmission is a TB split joint UE transmission, the second TB is different than the first TB.

14. The method of claim 13 wherein:
the first PDCCH includes an indication of whether the joint UE transmission is to be the TB duplicate joint UE transmission or the TB split joint UE transmission.

15. The method of claim 13 further comprising:
transmitting higher layer signalling indicating whether the joint UE transmission is the TB duplicate joint UE transmission or the TB split joint UE transmission.

16. The method of claim 13 wherein:
the first PDCCH contains scheduling information for only the first TB indicating that the TB duplicate joint UE transmission is being scheduled; or
the first PDCCH contains scheduling information for the first TB and a second TB indicating that the TB split joint UE transmission is being scheduled.

17. The method of claim 13 wherein:
the first PDCCH contains scheduling information for two TBs, and in a case where the scheduling information for the two TBs is the same, the duplicate TB joint UE transmission is being scheduled, and in a case where the scheduling information for the two TBs is different, the split TB joint UE transmission is being scheduled.

18. The method of claim 13 wherein the first PDCCH being scrambled with a first radio network temporary identifier (RNTI) indicates the TB duplicate joint UE transmission, or the first PDCCH being scrambled with a second RNTI indicates the TB split joint UE transmission.

19. The method of claim 13, wherein:
for the TB duplicate joint UE transmission, the first PDCCH contains a new data indicator (NDI) indicating whether a new transmission is being scheduled or a retransmission is being scheduled.

20. The method of claim 13, wherein:
for the TB split joint UE transmission, the first PDCCH contains a first new data indicator (NDI) indicating whether a new transmission or a retransmission is being scheduled for transmission by the first UE, and contains a second new data indicator (NDI) indicating whether a new transmission or a retransmission is being scheduled for transmission by the second UE.
